(19) United States
(12) Patent Application Publication
(10) Pub. No.: US 2009/0000755 A1
(43) Pub. Date: Jan. 1, 2009

(54) METHOD AND CASTING MOLD FOR FABRICATING HEAT SINKS WITH FINS

(76) Inventor: Shin-Yu LEE, Lujhou City (TW)

Correspondence Address: PATENTTM.US, P. O. BOX 82788, PORTLAND, OR, 97282-0788, US

(21) Appl. No.: 12/144,600

(22) Filed: Jun. 23, 2008

(30) Foreign Application Priority Data
Jun. 29, 2007 (TW) 096123714

(51) Int. Cl. B22D 19/00; B28B 7/34

(52) U.S. Cl. 164/109; 249/135

(57) ABSTRACT

A method and a mold for fabricating heat sinks with fins, which includes steps of: providing a casting mold having a casting channel and multiple lamination cavities communicating with the casting channel defined therein; inserting multiple laminations being capable of heat dissipating into the lamination cavities of the casting mold respectively to make each lamination having an edge protruding from the lamination cavity; pouring a liquid material into the casting channel to solidify and integrate with the edges of the laminations to form a casting; and removing the casting from the casting mold. Accordingly, the method and the casting mold not only accelerates and facilitates manufacturing of heat sinks, but also allows a high-density of fins to be formed on a heat sink.

### BACKGROUND OF THE INVENTION

1. Field of the Invention

The present invention relates to a mold and a method, and more particularly to a method and a casting mold for fabricating heat sinks with high-density fins.

2. Description of Related Art

A heat sink usually comprises a base with one or more flat surfaces and an array of fins or comb to increase the heat sink's surface area and thus increasing the heat dissipation rate.

Generally, heat sinks with fins may be fabricated by various mechanical-manufacturing processes. However, most of the processes are so time consuming, are unfavorable to mass production of heat sinks and can not guarantee a mass number of fins formed on the heat sink. This causes a bottleneck to heat dissipating efficiency improvement of conventional heat sink.

The present invention therefore provides a method and a casting mold for fabricating heat sinks with fins to obviate or mitigate the aforementioned problems.

### SUMMARY OF THE INVENTION

The main objective of the present invention is to provide a method and a casting mold for fabricating heat sinks with fins that guarantees heat sinks with mass number of fins being rapidly fabricated.

To achieve the objective, the casting mold in accordance with present invention comprises multiple mold dies mounted detachably adjacent to each other in stack, each mold die has an edge and an indentation formed in the edge. Furthermore, the casting mold has a surface, a casting channel and multiple lamination cavities.

The casting channel is defined in the surface of the casting mold, may be formed by the indentations of combined mold dies.

The lamination cavities are defined between each two adjacent mold dies and each lamination cavity has an opening communicating with the casting channel.

The method in accordance with present invention includes steps of:

1. Providing a casting mold in accordance with present invention.

2. Inserting multiple laminations being capable of heat dissipating into the lamination cavities of the casting mold respectively, and each lamination has an edge protruding from the lamination cavity.

3. Pouring a liquid material such as melt aluminum, copper, alloy thereof or the like into the casting channel to solidify and integrate with the edges of the laminations to form a casting.

4. Removing the casting from the casting mold, may be performed by detaching the mold dies from each other.

Accordingly, the casting of a heat sink comprising a base and multiple fins that formed by the laminations integrated with the base is provided.

It is noticed that, comparing to traditional mechanical-manufacturing processes, the method and the casting mold in accordance with present invention not only accelerates and facilitates manufacturing of heat sinks, but also allows a high-density of fins to be formed on a heat sink since that mass of lamination cavities defining in the casting mold are capable of holding mass of laminations inside.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a casting mold for fabricating heat sinks with fins in accordance with the present invention;

FIG. 2 is an exploded perspective view of the casting mold in FIG. 1;

FIG. 3 is a cross sectional side view of the casting mold in FIG. 1;

FIG. 4 is a perspective view of a heat sink fabricated by the method and the mold in accordance with present invention;

FIG. 5 is a perspective view of a second embodiment of a casting mold for fabricating heat sinks with fins in accordance with the present invention;

FIG. 6 is an exploded perspective view of the casting mold in FIG. 5;

FIG. 7 is a side view in partial section of the casting mold in FIG. 5;

FIG. 8 is a perspective view of another heat sink fabricated by the method and the mold in accordance with present invention;

FIG. 9 is a perspective view of a third embodiment of a casting mold for fabricating heat sinks with fins in accordance with the present invention;

FIG. 10 is an exploded perspective view of a fourth embodiment of a casting mold for fabricating heat sinks with fins in accordance with the present invention;

FIG. 11 is a perspective view of the casting mold in FIG. 10; and

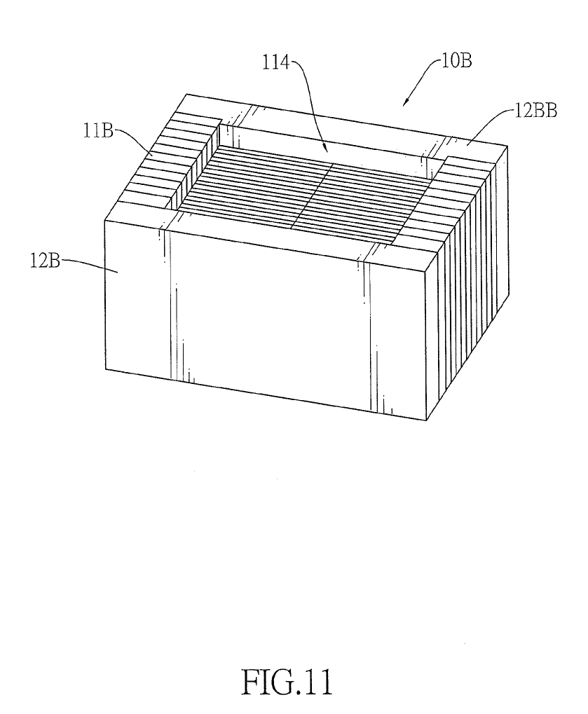

FIG. 12 is an operational exploded perspective view of the casting mold in FIG. 10 shown in another status.

### DETAILED DESCRIPTION OF THE PREFERRED EMBODIMENT

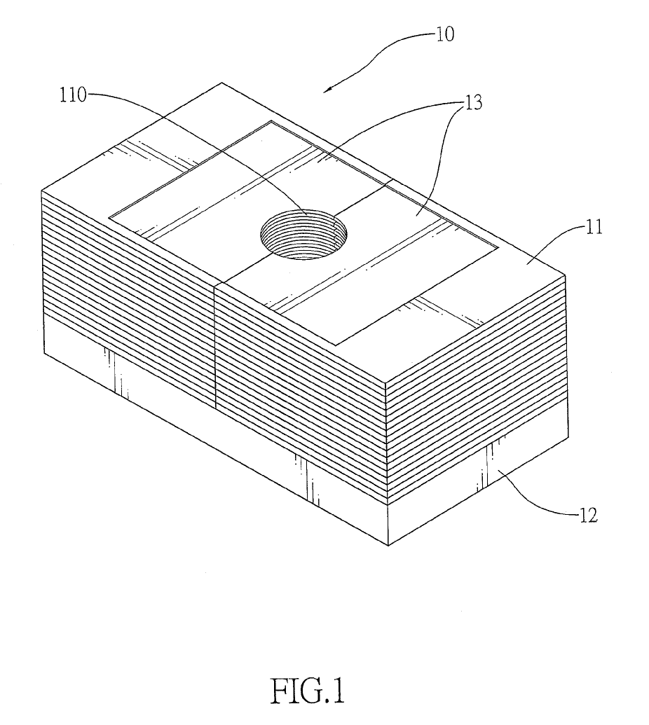

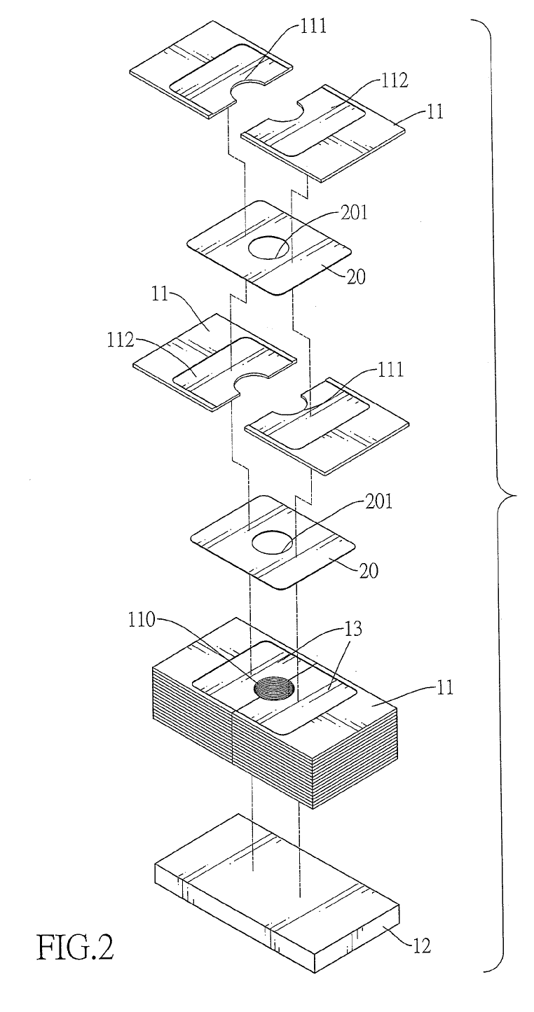

With reference to FIGS. 1 and 2, in the first embodiment, the casting mold (10) comprises a supporting board (12) and multiple mold dies (11).

The supporting board (12) has a surface. The mold dies (11) are mounted detachably on the surface of the supporting board (12) in two stacks. Each mold die (11) has an inner edge, a top surface, a recess (112) and an indentation (111). The inner edge corresponds to and is attached with an inner edge of one of the mold dies (11) of another mold dies stack. The recess (112) is formed in the top surface, each recess (112) between adjacent mold dies (11) define a lamination cavity (13). The indentation (111) is formed in the inner edge and is half-circular, thereby when the two mold dies stacks combine with each other, a columnar casting channel (110) having an internal diameter and communicating with the lamination cavities (13) is therefore defined by the indentations (111).

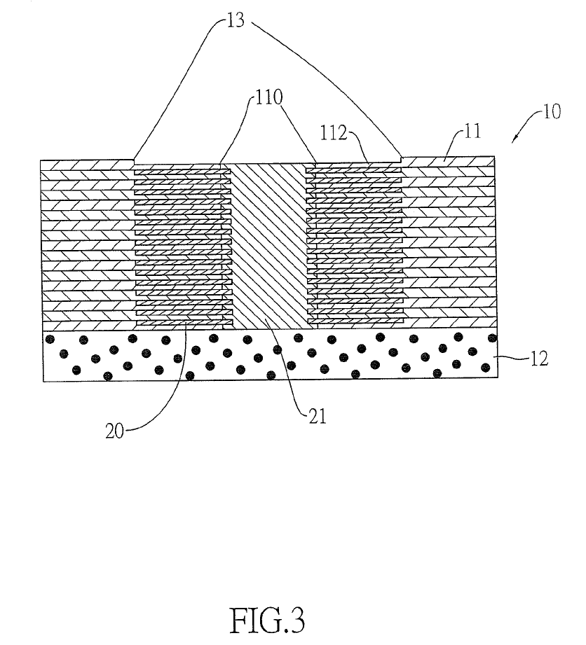

With further reference to FIG. 3, the method for fabricating heat sinks with fins with the casting mold (10) of the first embodiment includes steps of:

1. Providing a casting mold (10).

2. Preparing multiple laminations (20), each lamination (20) is capable of heat dissipating, may be metal and has a central hole (201) and an inner edge. The central hole (201) has an internal diameter smaller than the internal diameter of the casting channel (110). The inner edge is defined around the central hole (201).

3. Separating the two stacks of mold dies (11).

4. Inserting the laminations (20) into the lamination cavities (13) of the casting mold (10) respectively to make the central hole (201) of each lamination (20) corresponding to a corresponding casting channel (110). The inner edge of each lamination (20) protrudes from the corresponding lamination cavity (13) and extends into the corresponding casting channel (110).

5. Assembling the two stacks of mold dies (11).

6. Pouring a liquid material such as melt aluminum, copper, alloy thereof or the like into the casting channel (110) to solidify and integrate with the inner edges of the laminations (20) in the casting channel (110) to form a casting.

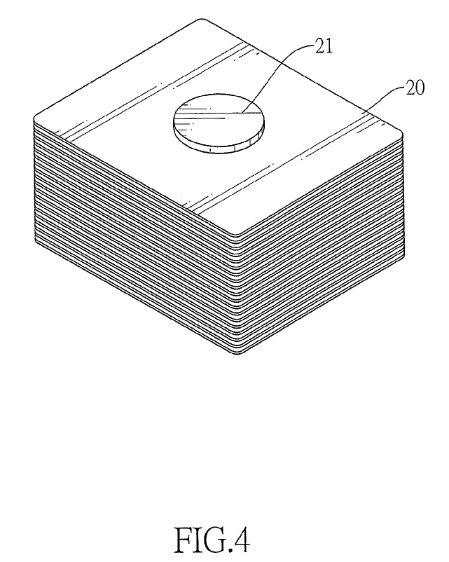

7. Removing the casting, with further reference to FIG. 4, from the casting mold (10), and may be performed by detaching the mold dies (11) from each other.

8. Cleaning and trimming the casting.

Accordingly, the casting of a heat sink comprising a columnar base (21) and multiple transverse fins formed by the laminations (20) integrated with the base (21) is provided.

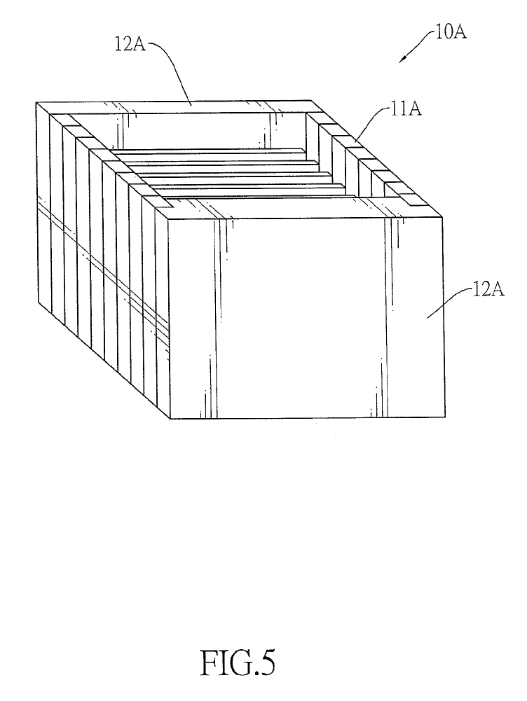

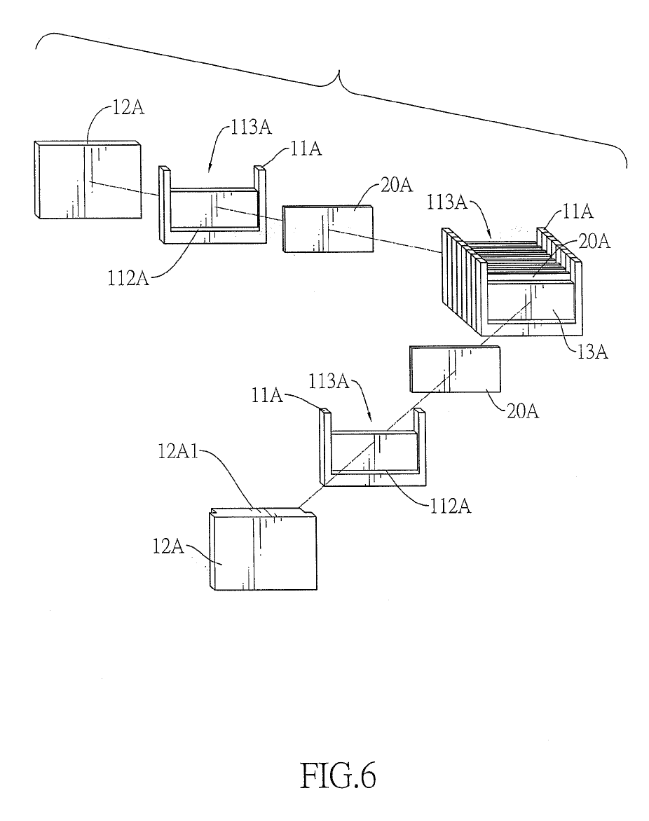

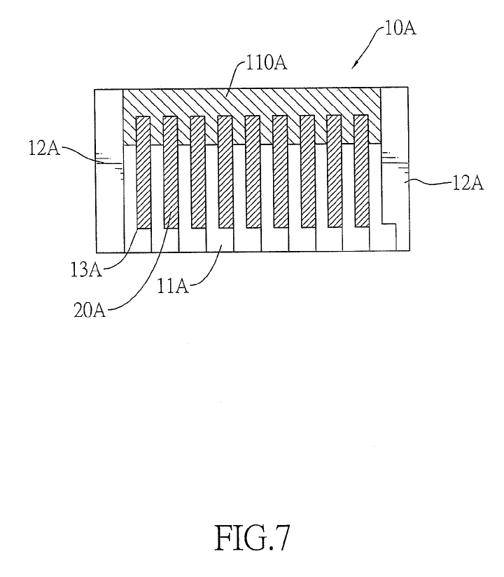

With reference to FIGS. 5, 6 and 7, in the second embodiment, the casting mold (10A) comprises two sideboards (12A) and multiple mold dies (11A).

The sideboards (12A) are separately implemented perpendicularly on a plane surface and have inner surfaces facing to each other, and the inner surface of one of the sideboards (12A) has a lump (12A1).

The mold dies (11A) are mounted detachably adjacent to each other between the inner surfaces of the sideboards (12A). Each mold die (11A) has a top edge, two surfaces, a recess (112A) and an indentation (113A).

The recess (112A) is formed in one of the surfaces, the recess (112A) of each mold die (11A) defines a lamination cavity (13A), wherein one of the recesses (112A) of the mold dies (11A) engages with the lump (12A1) of the sideboard (12A). Each lamination cavity (13A) has a width, a depth and a top opening.

The indentation (113A) is formed in the top edge of each mold die (11A) and defines a rectangular casting channel (110A) communicating with the lamination cavities (13A) via the top openings.

The method for fabricating heat sinks with fins with the casting mold (10A) of the second embodiment includes steps of:

1. Providing a casting mold (10A).

2. Preparing multiple laminations (20A), each lamination (20A) is capable of heat dissipating, may be metal and has a top edge, a width equal to the width of the lamination cavity (13A) and a length longer than the depth of the lamination cavity (13A).

3. Inserting the laminations (20A) into the lamination cavities (13A) of the casting mold (10A) respectively to make the top edge of each lamination (20A) protruding from the corresponding lamination cavity (13A) and extending into the casting channel (110A).

4. Pouring a liquid material such as melt aluminum, copper, alloy thereof or the like into the casting channel (110A) to solidify and integrate with the top edges of the laminations (20A) in the casting channel (110A) to form a casting.

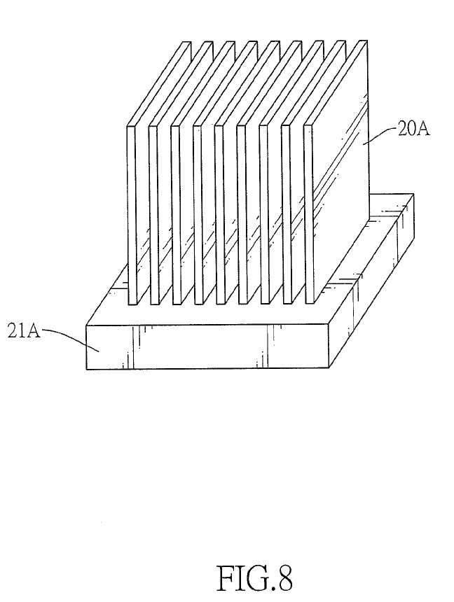

5. Removing the casting, with further reference to FIG. 8, from the casting mold (10A), may be performed by detaching the mold dies (11A) from each other.

6. Cleaning and trimming the casting.

Accordingly, the casting of a heat sink comprising a rectangular base (21A) and multiple perpendicular fins formed by the laminations (20A) integrated with the base (21A) is provided.

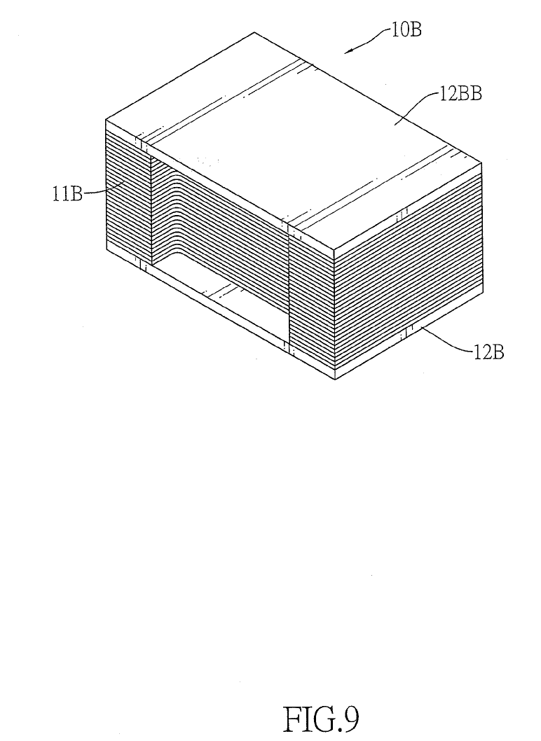

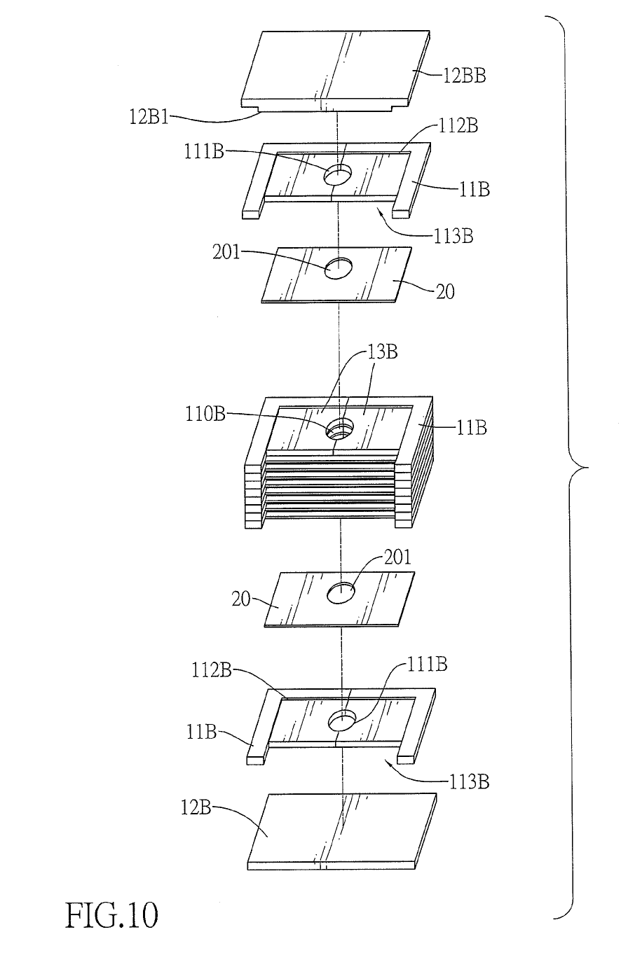

With reference to FIG. 9, in the third embodiment, or in an alternative fourth embodiment shown in FIG. 10, the casting mold (10B) for both methods of the first and second embodiments comprises a supporting board (12B), an optional auxiliary board (12BB) and multiple mold dies (11B).

The supporting board (12B) has a surface.

The auxiliary board (12BB) has a clamping surface opposite to the surface of the supporting board (12B).

Each mold die (11B) includes two halves and has a top surface, a recess (112B), a side edge and a side indentation (113B).

The recess (112B) is formed in the top surface, each recess (112B) between adjacent mold dies (11B) defines a lamination cavity (13B) respectively. Each lamination cavity (13B) has a width, a depth and an opening formed in the side edge.

The side indentation (113B) is formed in the side edge of each mold die (11B) and defines a rectangular casting channel (114) communicating with the lamination cavities (13B) via the opening.

Preferably, each half of the mold die (11B) has an inner edge and an inner indentation (111B). The inner edge of the half corresponds to and is attached with the inner edge of another half of the mold die (11B). The inner indentation (111B) is formed in the inner edge and is half-circular, thereby when the halves of each mold die (11B) combine with each other, a columnar casting channel (110B) having an internal diameter and communicating with the lamination cavities (13B) is therefore defined by the indentations (111B).

The method for fabricating heat sinks of the first embodiment includes steps of:

1. Mounting the mold dies (11B) detachably on the surface of the supporting board (12B) in a stack.

2. Preparing multiple laminations (20), each lamination (20) is capable of heat dissipating, may be metal and has a central hole (201) and an inner edge. The central hole (201) corresponds to the columnar casting channel (110B) and has an internal diameter smaller than the internal diameter of the columnar casting channel (110B). The inner edge is defined around the central hole (201).

3. Inserting the laminations (20) into the lamination cavities (13B) of the casting mold (10B) via the openings respectively to make the inner edge of each lamination (20) protruding from the columnar casting channel (110B) and extending into the columnar casting channel (110B).

4. Pouring a liquid material such as melt aluminum, copper, alloy thereof or the like into the columnar casting channel (110B) to solidify and integrate with the inner edges of the laminations (20) in the columnar casting channel (110B) to form a casting.

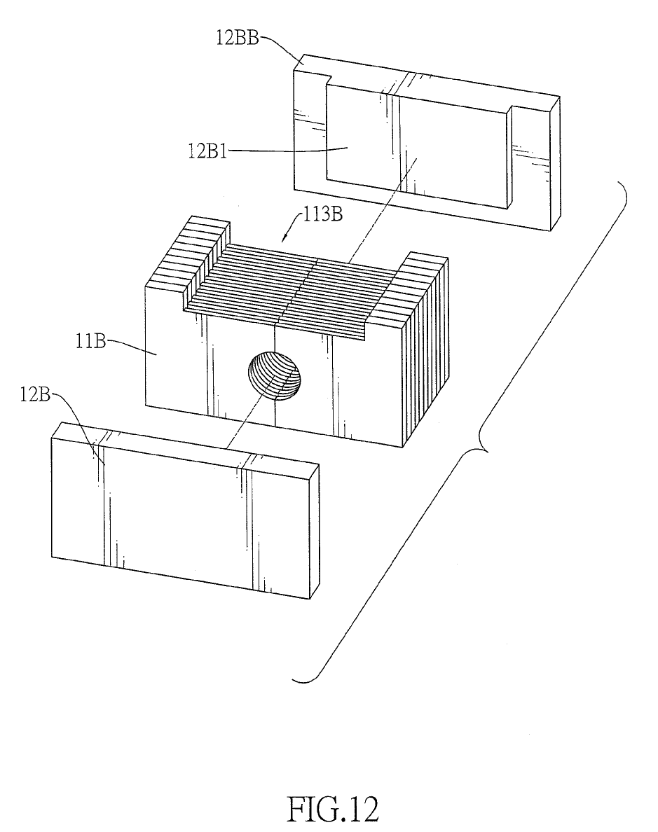

5. Removing the casting, with further reference to FIG. 12, from the casting mold (10B), and may be performed by detaching the halves of each mold dies (11B) from each other.

6. Cleaning and trimming the casting.

Accordingly, the casting of a heat sink comprising a columnar base (21) and multiple transverse fins that formed by the laminations (20) integrated with the base (21) is provided.

The method for fabricating heat sinks of the second embodiment includes steps of:

1. Mounting the mold dies (11B) detachably adjacent to each other between the supporting board (12B) and the auxiliary board (12BB) to form the rectangular casting channel (114) in a top of the casting mold (10B).

2. Preparing multiple laminations (20A), each lamination (20A) is capable of heat dissipating, may be metal and has a top edge, a width equal to the width of the lamination cavity (13B) and a length longer than the depth of the lamination cavity (13B).

3. Inserting the laminations (20A) into the lamination cavities (13B) of the casting mold (10B) respectively to make the top edge of each lamination (20A) protruding from the corresponding lamination cavity (13B) and extending in the casting channel (114).

4. Pouring a liquid material such as melt aluminum, copper, alloy thereof or the like into the casting channel (114) to solidify and integrate with the top edges of the laminations (20A) in the casting channel (114) to form a casting.

5. Removing the casting from the casting mold (10B), may be performed by detaching the mold dies (11B) from each other.

6. Cleaning and trimming the casting.

Accordingly, the casting of a heat sink comprising a rectangular base (21B) and multiple perpendicular fins that formed by the laminations (20B) integrated with the base (21B) is provided.

Even though numerous characteristics and advantages of the present invention have been set forth in the foregoing description together with details of the structure and function of the invention, the disclosure is illustrative only. Changes may be made in detail especially in matters of shape, size, and arrangement of parts within the principles of the invention to the full extent indicated by the broad general meaning of the terms in which the appended claims are expressed.

What is claimed is:

1. A casting mold for fabricating heat sinks with fins comprising
multiple mold dies mounted detachably adjacent to each other, each mold die having
an edge; and
an indentation formed in the edge;
a casting channel being formed by the indentations of the mold dies; and
multiple lamination cavities being defined between each two adjacent mold dies, each lamination cavity having an opening communicating with the casting channel.

2. The casting mold as claimed in claim 1, further comprising a supporting board having a surface, wherein
the mold dies are mounted detachably on the surface of the supporting board in two stacks, and each mold die further has
an inner edge corresponding to and attached with an inner edge of a corresponding mold die of another mold dies stack;
a top surface;
a recess being formed in the top surface, and each recess between adjacent mold dies defining a lamination cavity respectively; and
the indentation being formed in the inner edge and being half-circular to define a columnar casting channel having an internal diameter and communicating with the lamination cavities when the mold dies of the two stacks combine with each other.

3. The casting mold as claimed in claim 1 further comprising two sideboards being separately implemented perpendicularly on a plane surface and having inner surfaces facing to each other, wherein
the mold dies being mounted detachably adjacent to each other between the inner surfaces of the sideboards, each mold die having
a top edge,
two surfaces,
a recess being formed in one of the surfaces and defining a lamination cavity having a width, a depth and a top opening; and
the indentation being formed in the top edge of the mold die and defining a rectangular casting channel communicating with the lamination cavity via the top opening.

4. The casting mold as claimed in claim 3, wherein the inner surface of one of the sideboards further has a lump; and the recess of one of the mold dies engages the lump.

5. A casting mold for fabricating heat sinks with fins comprising
a supporting board having a surface; and
multiple mold dies, each mold die including two halves and having
a top surface;
a bottom surface;
a side edge;
a recess being formed in the top surface, each recess between adjacent mold dies defining a lamination cavity respectively, each lamination cavity having a width, a depth and an opening formed in the side edge; and
a side indentation being formed in the side edge of the mold die and defining a rectangular casting channel communicating with the lamination cavity via the opening,
wherein each half of each mold die has
an inner edge corresponding to and attached with the inner edge of another half of the mold die; and
an inner indentation being formed in the inner edge and being half-circular to define a columnar casting channel having an internal diameter and communicating with the lamination cavities when the halves of each mold die combined with each other.

6. The casting mold as claimed in claim 5 further comprising an auxiliary board having a clamping surface opposite to the surface of the supporting board.

7. A method of using a casting mold as claimed in claim 2 including steps of:
preparing multiple laminations, each lamination being capable of heat dissipating and having
a central hole having an internal diameter smaller than the internal diameter of the casting channel; and
an inner edge being defined around the central hole;
separating the two stacks of mold dies;
inserting the laminations into the lamination cavities of the casting mold respectively to make the central hole of each lamination corresponds to the casting channel, and the inner edge of each lamination protruding from the corresponding lamination cavity and extending into the casting channel;
assembling the two stacks of mold dies;
pouring a liquid material into the casting channel to solidify and integrate with the inner edges of the laminations in the casting channel to form a casting;
removing the casting from the casting mold.

8. A method of using the casting mold as claimed in claim 3 including steps of:
preparing multiple laminations, each lamination being capable of heat dissipating and having a top edge, a width equal to the width of the lamination cavity and a length longer than the depth of the lamination cavity;
inserting the laminations into the lamination cavities of the casting mold respectively to make the top edge of each lamination protruding from the corresponding lamination cavity and extending into the casting channel;
pouring a liquid material into the casting channel to solidify and integrate with the top edges of the laminations in the casting channel to form a casting; and
removing the casting from the casting mold.

9. A method of using the casting mold as claimed in claim 5 including steps of:
mounting the mold dies detachably on the surface of the supporting board in a stack;
preparing multiple laminations, each lamination being capable of heat dissipating and having
a central hole corresponding to the columnar casting channel and having an internal diameter smaller than the internal diameter of the columnar casting channel; and
an inner edge being defined around the central hole;
inserting the laminations into the lamination cavities of the casting mold via the openings respectively to make the inner edge of each lamination protruding from the columnar casting channel and extending into the columnar casting channel;
pouring a liquid material into the columnar casting channel to solidify and integrate with the inner edges of the laminations in the columnar casting channel to form a casting; and
removing the casting from the casting mold.

10. A method of using the casting mold as claimed in claim 6 including steps of:
mounting the mold dies detachably adjacent to each other between the supporting board and the auxiliary board to make the rectangular cavity formed in a top of the casting mold;
preparing multiple laminations, each lamination being capable of heat dissipating and having a top edge, a width equal to the width of the lamination cavity and a length longer than the depth of the lamination cavity;
inserting the laminations into the lamination cavities of the casting mold respectively to make the top edge of each lamination protruding from the corresponding lamination cavity and extending into the casting channel;
pouring a liquid material into the casting channel to solidify and integrate with the top edges of the laminations in the casting channel to form a casting; and
removing the casting from the casting mold.

11. The method as claimed in claim 10, wherein removing the casting is performed by detaching the halves of the mold dies from each other.

12. The method as claimed in claim 10, wherein the liquid material is melt aluminum.

13. The method as claimed in claim 10, wherein the liquid material is melt copper.
